(19) United States
(12) Patent Application Publication
(10) Pub. No.: US 2025/0224732 A1
(43) Pub. Date: Jul. 10, 2025

(54) METHOD FOR DETERMINING POINT GROUPS WHICH ARE VISIBLE OR NOT VISIBLE FROM A SPECIFIED VIEWING POINT

(71) Applicant: Robert Bosch GmbH, Stuttgart (DE)

(72) Inventors: Christian Juette, Redwood City, CA (US); Stefan Benz, Kirchentellinsfurt (DE)

(21) Appl. No.: 18/850,212

(22) PCT Filed: May 3, 2023
(86) PCT No.: PCT/EP2023/061646

§ 371 Date: Sep. 24, 2024

(30) Foreign Application Priority Data
May 9, 2022 (DE) 10 2022 204 515.7

(51) Int. Cl. G05D 1/622; G01C 21/00; G01S 17/931

(52) U.S. Cl. CPC G05D 1/622; G01C 21/3841; G01S 17/931

(57) ABSTRACT

A method for determining a target quantity of point groups in a surrounding area. The point groups being visible or not visible from a specified viewing point in the surrounding area, from a quantity of point groups. The method includes: providing the quantity of point groups in the surrounding area, with coordinates in an origin coordinate system, transforming the coordinates of the quantity of point groups into spherical coordinates in a target coordinate system, wherein the viewing point lies in the surrounding area in the origin of the target coordinate system, determining a spherically curved grid in spherical coordinates in the target coordinate system, assigning each point group of at least some of the quantity to a cell or a grid point.

### FIELD

The present invention relates to a method for determining a target quantity of point groups visible or not visible from a specified viewing point, a system for data processing and a computer program for carrying out the same, and a device for using such a target quantity of point groups.

### BACKGROUND INFORMATION

Devices such as vehicles or robots that move at least semi-automatically move along a movement path in a surrounding area such as a home, in a garden, on a factory floor or on the road, in the air or in water. For this purpose, it is required that a current position and/or orientation (also referred to as a pose) of the mobile device is known and can be determined again and again. For this purpose, laser distance measurement (e.g., with so-called lidar sensors), can be used for example. It is also possible to detect surrounding area information such as images of the surrounding area (e.g., by means of a camera).

### SUMMARY

According to the present invention, a method for determining a target quantity of point groups, a system for data processing and a computer program for carrying it out, and a device for using such a target quantity of point groups are provided. Advantageous example embodiments of the present invention are disclosed herein.

The present invention relates to quantities of points or a so-called point cloud in a surrounding area. Such points or point clouds are obtained, for example, by means of a lidar sensor or other type of distance measurement and then indicate in each case a reflection point, e.g., of a laser beam in the surrounding area, which has been emitted by the lidar sensor. If these points are viewed in a coordinate system with the lidar sensor at its origin, spacing or distances to objects in the surrounding area can be indicated based on the points or their coordinates. For example, in the case of devices, in particular mobile devices such as mentioned at the outset, this can allow for the orientation in the surrounding area and, based on this, (automated) navigation and, in particular, movement of the device in the surrounding area.

A further option for such devices is to detect surrounding area information such as images, for example by means of a camera. Such images, which may also be semantically analyzed in order to recognize specific objects, can also be used for orientation in the surrounding area and, based on this, (automated) movement of the device in the surrounding area.

If both types of surrounding area detection, i.e., the mentioned points or point cloud on the one hand and surrounding area information such as images on the other hand, are available, the points can be associated with the surrounding area information, for example the distances of the points can be mapped onto an image. It can be assumed, for example, that for an application, labels predicted by an image classification algorithm in such an image are to be mapped onto lidar point clouds of the same scene in the surrounding area in order to extend the semantic information with 3D information.

In practice, however, the point cloud, on the one hand, and the surrounding area information, on the other hand, are detected or recorded from different angles or from different viewing points, for example in the case of a device with a lidar sensor and camera. This results in a visibility problem due to the different viewing angles of the lidar and camera. In particular at the edges of objects in the surrounding area, it may happen that the lidar sensor sees or detects, for example, two separate points in the surrounding area that are further away than the object, but the camera only sees or detects one of these points. The other point, however, is obscured by the object.

Therefore, if information from the camera were mapped onto the lidar point cloud or vice versa without analyzing the visibility of the points from the viewing point of the camera (camera position), the point not detected by the camera would be incorrectly labeled with, for example, a color or label from the upper side of the object. In general, this actually invisible point—and thus its distance, which is greater than that of the object—would be mapped onto the object or its surface.

The problem of which points of a point cloud are visible from a certain viewing point can be solved, for example, with “Hidden Point Removal” by S. Katz et al., “ACM Transactions on Graphics,” volume 26, issue 3, July 2007 pp 24-es. This approach is also successfully applied to the task of camera lidar mapping by Vechersky et al, “Colourising Point Clouds Using Independent Cameras,” in IEEE Robotics and Automation Letters, vol. 3, no. 4, pp. 3575-3582 October 2018.

The approach of Katz et al. describes an operator with which all points of the given point cloud are “inverted.” This is also referred to as “spherical flipping,” since all points are mirrored on a sphere that contains all points (the transformation function can also be a different one). The approach then constructs a convex hull from the inverted point cloud and the coordinate center of the camera. There, it is shown that every point that lies on this convex hull is visible to the camera, all other points are not and can be removed.

Other approaches to solving this problem are based, for example, on surface reconstructions and then use methods of so-called raycasting or the like.

The present invention provides a procedure for determining a target quantity of point groups visible or not visible from a specified viewing point in the surrounding area from an (existing) quantity of point groups. A point group can, for example, comprise only one (individual) point or a plurality of points. As will be explained in more detail later, point groups of the quantity can be different from one another. In other words, points in the quantity can be grouped.

Although the procedure according to the present invention is described below in particular in relation to the example mentioned with a lidar sensor and camera that detect (or see) the surrounding area from different viewing points or viewing angles, it can be used to determine a target quantity from any quantity of points or point groups which are visible (or not visible) from a specified viewing point in the surrounding area.

According to an example embodiment of the present invention, the quantity of point groups in the surrounding area is initially provided, specifically with coordinates in an origin coordinate system. Here, points of the point groups or the point groups themselves can be present, for example, in Cartesian or spherical coordinates. For example, the quantity of point groups in the surrounding area can be or have been determined by means of distance measurement, in particular by means of a lidar sensor. A starting point of the distance measurement, in particular a position of the lidar sensor, then lies in particular in an origin of the origin coordinate system.

The coordinates of the quantity of point groups are then transformed into spherical coordinates in a target coordinate system, wherein the viewing point (from which the points to be determined are to be visible, for example the location of the camera) lies in the surrounding area in the origin of the target coordinate system.

Furthermore, a spherically curved grid is determined in spherical coordinates in the target coordinate system, wherein the grid comprises grid points and/or cells. In particular, the grid points and/or cells are arranged uniformly. A simple example of this would be a grid on a spherical surface with the center of the associated sphere in the origin of the target coordinate system, wherein the grid lines are uniformly spaced in the polar and azimuth directions. In this way, four neighboring grid points (where two grid lines intersect) in each case form a cell, with the four grid points as corners. The underlying idea here is the way points are detected by a typical lidar sensor, specifically with uniform spacings in the polar and azimuth directions. If such a grid were created for a lidar sensor in the origin coordinate system, it would be possible to assign exactly one point or point group to each cell, depending on the spacings of the grid lines. Such a uniform arrangement can be used in particular universally, i.e., for different surrounding areas. However, a non-uniform arrangement of the grid points and/or cells is also possible. For example, cells or grid points in the region of the floor and/or ceiling (in the surrounding area, e.g., a hall) can be arranged more finely or more densely than in the rest, since no occlusions are typically to be expected in the rest.

For the grid in the target coordinate system, each point group (which can also comprise, for example, only one point in each case) is now assigned to a cell or a grid point from at least some of the quantity. Since the origin of the target coordinate system (the desired viewing point and thus the center of the spherically curved grid) does not coincide with the origin of the origin coordinate system (in which, for example, the lidar sensor with which the points of the quantity have been detected), it may happen that a cell can no longer be assigned exactly one point or one point group; it may happen that a plurality of point groups can be assigned to a cell. The assignment of a point to a cell is effected based on the spherical coordinates.

Figuratively speaking, the connecting line between the origin of the origin coordinate system and a certain point would intersect exactly one of the cells; the points can then be assigned to this cell. If there is a plurality of points per point group, an average value of the coordinates of the points, for example, can also be used. A plurality of points per point group can be considered, for example, if this plurality of points have been detected with a lidar sensor at the same time or very close to one another. Since the cells are or at least can be defined by the grid points, a point group can also be assigned to a grid point instead of a cell, for example the point closest to the intersection of the imaginary connecting line on the spherical surface with the grid.

Against this background, cells or grid points assigned to more than one point group can then be determined. A minimum or maximum spacing from the origin of the target coordinate system is then determined for each of at least some of these grid cells or for each of at least some of these grid points (for this purpose, there is then also a corresponding point group). For this purpose, the spacing from the origin of the target coordinate system can be determined, for example, for each point group per cell or grid point. The spacing of a point from the origin corresponds to the radial coordinate in spherical coordinates. If a point group comprises a plurality of points, an average spacing between the plurality of points can be used or in each case the minimum or maximum spacing that occurs between the plurality of points in the point group.

Based on this, the target quantity of point groups which are visible from a specified viewing point in the surrounding area can then be determined in such a way that it comprises those point groups whose spacing from the origin of the target coordinate system per cell or grid point corresponds to the minimum spacing or exceeds the minimum spacing by at most a specified first threshold value, and/or whose spacing from the origin of the target coordinate system per cell or grid point is less than the maximum spacing minus a specified second threshold value. In addition, those point groups that are assigned to cells or grid points to which only one point group is assigned can also be comprised.

To achieve this, one or more point groups can be identified for each cell or grid point, for example, whose spacing from the origin of the target coordinate system is greater than the minimum spacing or exceeds the minimum spacing by more than a specified first threshold value, and/or whose spacing from the origin of the target coordinate system exceeds the maximum spacing minus a specified second threshold value. These can then be removed from the quantity, and the remaining point group of the quantity can then be provided as the target quantity.

The idea here is that from the desired viewing point-if there were a lidar sensor there-only one point or point group would be in a cell. If, on the other hand, two or more points or point groups are assigned to a cell that have very different spacings, not all of these points or point groups could have been detected by a lidar sensor. The point with the shortest spacing would be created by a nearby object, the point with a significantly greater spacing would lie behind the object and could not be detected at all.

If all points or point groups whose spacing from the origin of the target coordinate system is greater than the minimum spacing are now removed from the quantity, only points or point groups that are or would be visible from the desired viewing point remain in the quantity. It can be provided that only points or point groups are removed whose spacing from the origin of the target coordinate system exceeds the minimum spacing by more than a specified first threshold value. This first threshold value can depend on the minimum spacing, in particular correspond to the respective minimum spacing multiplied by a respective factor. This takes account of the fact that points that are only slightly further away than the minimum spacing will not lie behind an object in practice, but still on the surface of the object, which is, for example, at a slight angle in the surrounding area, so that the spacing there is slightly greater. By selecting the first threshold value as zero, the minimum spacing (only) can also be set in this way.

Such points or point groups can also be identified by searching for points or point groups whose spacing from the origin of the target coordinate system exceeds the maximum spacing minus a specified second threshold value. If the second threshold value is selected appropriately, this also identifies points or point groups that should not actually be visible from the viewing point. This second threshold value can depend on the maximum spacing, in particular correspond to the respective maximum spacing multiplied by a respective factor.

However, the target quantity can also be obtained by directly outputting as the target quantity those point groups whose spacing from the origin of the target coordinate system per cell or grid point exceeds the minimum spacing by no more than a specified first threshold value (or, with threshold value zero, corresponds to the minimum spacing) and/or whose spacing from the origin of the target coordinate system per cell or grid point falls below the maximum spacing minus a specified second threshold value. Even those point groups that are assigned to cells or grid points to which only one point group is assigned can be comprised in the target quantity, because the only spacing there also corresponds to the minimum spacing.

However, these identified points or point groups also represent those points or point groups in the quantity which are not visible from the specified viewing point in the surrounding area. If, for example, exactly these points or point groups are desired for a certain application, they can be determined as the target quantity.

The procedure according to the present invention is significantly faster than, for example, the options mentioned at the outset, since it requires neither a surface reconstruction nor a convex hull. Both tasks are complex to calculate, in particular for larger point clouds. The above-mentioned approach for estimating the visibility of point clouds has a time complexity of order O (n*log n), and a typical approach for surface reconstruction has a time complexity of order O (n\hat{ }2). The procedure proposed within the framework of the present invention, on the other hand, only has a time complexity of order O (n) and still provides suitable results, for example for the application with lidar sensor and camera. In practice, this results in time savings of an order of magnitude.

In addition, the procedure according to the present invention is simple and quick to implement and is therefore suitable as a quick solution to the problem described. It has also been shown that the approach of Katz et al. filters out many points in the distance and on the ground that are actually visible from the viewing point. The proposed procedure retains these points. Even if slightly more false positives are to occur, this is negligible in practice.

According to an example embodiment of the present invention, preferably, determining the grid in spherical coordinates in the target coordinate system comprises determining the coordinates of the quantity of point groups in the origin coordinate system in spherical coordinates or, if necessary, using them in spherical coordinates (if the points or point groups are already present in this form). A frequency distribution of the point groups in the polar direction can then be determined. Based on a number of local maxima of the frequency distribution, a dimension (as an angle) of the cells or of spacings (as an angle) of the grid points in polar direction can then be determined. The number itself results in a dimension of the cell corresponding to the underlying lidar sensor, but it can also be doubled or another suitable value can be selected. A dimension (as an angle) of the cells or the spacings (as an angle) of the grid points in the azimuth direction can be determined based on a number of point groups per local maximum. Here, the number itself also results in a dimension of the cell corresponding to the underlying lidar sensor, but it can also be doubled or another suitable value can be selected. In this way, the grid itself can also be determined automatically.

Advantageously, according to an example embodiment of the present invention, a dimension of the cells or spacings of the grid points in the polar direction and/or a dimension of the cells or spacings of the grid points in the azimuth direction is determined based on a distance of the specified viewing point from an origin of the origin coordinate system. The further apart the sensors (lidar sensor and camera) are, for example, the larger the cells can be selected.

According to an example embodiment of the present invention, preferably, surrounding area information, with coordinates in the target coordinate system, for example image information and/or semantic information, is also provided. Then at least some of the point groups of the target quantity of point groups which are visible from a specified viewing point in the surrounding area can be associated with the surrounding area information. In other words, points with distance information, for example, can be mapped onto an image.

This also enables, for example, the determination of control information for moving a device based on the surrounding area information and the associated point groups of the target quantity. This control information can then be provided (for the device), so that the device can be controlled, in particular based on the control information, for example moved in the surrounding area.

The procedure according to the present invention can be used in particular whenever the visibility of points in a point cloud has to be derived from a certain viewing angle. This applies both to artificially generated point clouds (e.g., from a CAD model) and to recorded real data (e.g., point clouds from a lidar sensor that are to be transformed into a different viewing angle, as explained in detail above).

One example application for the procedure according to the present invention can be the combination of a (if applicable, different) range sensor (e.g., lidar or radar) and a (if applicable, different) image-based sensor (e.g., camera or thermal imaging device). The proposed procedure can be used in such systems in order to improve data quality by harmonizing the two data sources. As a result, many other algorithms can benefit from the improved data quality and quantity (since the data now contains not only image/semantic or 3D information, but both).

The procedure according to the present invention can generally be used in order to transform the position of a point cloud source “correctly,” i.e., with visibility constraints and not only with a distortion of the reference frame. The proposed procedure can also be used for the fusion of a plurality of point cloud sources (lidar, radar, stereovision, structured light) into a point cloud from any (virtual) viewing angle.

The procedure according to the present invention can also be used, for example, to simulate a virtual (lidar) sensor, for example in synthetic surrounding areas or on real data. A special application of the proposed procedure is the recognition of boxes and other objects, for example in warehouse surrounding areas, using a lidar and a camera sensor. For this purpose, the proposed procedure can improve the mapping of RGB data from a camera and semantic labels of these camera images to a lidar point cloud. The point cloud could then be accumulated and objects in it can be recognized. The proposed procedure can also be used within the framework of autonomous driving, for example, if information from a lidar sensor or radar sensor and one or more cameras is or is to be combined.

A system for data processing according to the present invention comprises means for performing the method according to the present invention or method steps thereof. The system can be a computer or server, e.g., in a cloud or cloud surrounding area. In the case of the application for a (mobile) device, the quantity of point groups can then be transmitted there (e.g., via a wireless data connection), and the target quantity can then be transmitted back to the device. It is also possible that such a system for data processing is a computer or a control unit in such a (mobile) device.

The present invention also relates to a device that is configured to provide a quantity of point groups in a surrounding area, with coordinates in an origin coordinate system, and preferably also to provide surrounding area information with coordinates in a target coordinate system. The device is further configured to obtain a target quantity of point groups visible or not visible from a specified viewing point in the surrounding area, which has been determined from the quantity of points according to a method according to the present invention. Preferably, the device has a distance measurement or lidar sensor for detecting the point groups in the surrounding area, further preferably also a sensor, in particular an image sensor, for detecting surrounding area information, further preferably also a control and/or regulation unit and a drive unit for moving the device. As mentioned, the system for data processing can also be comprised in the device.

The device is preferably designed as an at least partially automated moving vehicle, in particular as a passenger transportation vehicle or as a goods transportation vehicle, and/or as a robot, in particular as a household robot, for example a vacuuming and/or mopping robot, floor or a street cleaning device or a lawn mowing robot, and/or as a drone.

Furthermore, the implementation of a method according to the present invention in the form of a computer program or computer program product having commands or program code for performing the method or the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can be wired or wireless (e.g., via a WLAN network or a 3G, 4G, 5G or 6G connection, etc.).

Further advantages and embodiments of the present invention can be found in the disclosure herein.

The present invention is shown schematically in the figures based on exemplary embodiments and is described below with reference to the figures.

### BRIEF DESCRIPTION OF THE DRAWINGS

FIG. 1 schematically shows a device in a surrounding area to explain an example embodiment of the present invention.

FIG. 2 shows the surrounding area from FIG. 1 with further details.

FIG. 3 shows a grid to explain an example embodiment of the present invention.

FIG. 4 shows various spacings between points.

FIG. 5 shows a sequence of a method according to the present invention in a preferred example embodiment.

FIGS. 6A and 6B show representations for before and after the application of a method according to the present invention in a preferred embodiment.

### DETAILED DESCRIPTION OF EXAMPLE EMBODIMENTS

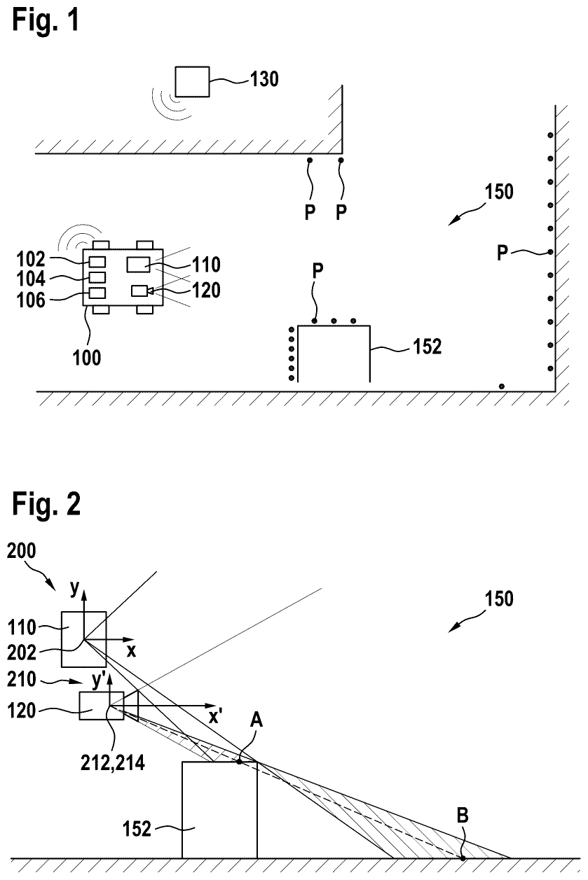

FIG. 1 schematically shows a representation of a device 100 in a surrounding area 150, based on which the present invention is to be explained. The device 100 is, for example, a robot or an automated (or autonomous) driving vehicle, with a drive unit 102, a control and/or regulation unit 106 and a communication and computing unit 106, via which a wireless data connection with a system for data processing 130, for example a server, is possible. In addition, the device 100 has a lidar sensor 110 for laser distance measurement and a camera 120 for detecting images of the surrounding area 150. In particular, the device 100 can be a device according to the present invention in a preferred embodiment.

The surrounding area 150 is by way of example the interior of a building, for example a corridor with side walls. An object 152 or obstacle is shown on one side wall by way of example. It can be provided, for example, that, by means of the lidar sensor 110 and the camera 120, information (distance and image information) of the surrounding area 150, based on which the device 100 is then to be moved in the surrounding area 150, is to be detected. For example, it can be provided that the device 100 is to move along the corridor, but in doing so is to move around the object 152.

For this purpose, the surrounding area 150 can be scanned by means of the lidar sensor 110. The laser scanner is moved in the lidar sensor, while a large number or quantity of points P is obtained by means of emitted laser beams and received, reflected radiation; each point represents a point or a small area in the surrounding area, for example on an object from which reflected radiation is received.

FIG. 2 shows the surrounding area 150 from FIG. 1 again. Only the lidar sensor 110 and the camera 120 of the device are shown. In particular, it can be seen that the lidar sensor 110 and the camera 120 are spatially separated from one another and thus also have different viewing points or viewing angles for the surrounding area 150. Although the situation is only shown here in two dimensions, the lidar sensor 110 and the camera 120 can also be at a spacing from one another in the third dimension, but do not have to be. In addition, two points A and B are selected and shown by way of example from the quantity of points P in FIG. 1.

Based on FIG. 2, it is apparent that the lidar sensor 110 can see or detect both point A and point B. However, the camera 120 can only see or detect point A due to its different viewing angle or viewing point 214. Thus, if information from the camera were mapped onto the lidar point cloud (the quantity of points P that also comprise A and B), or vice versa, without analyzing the visibility of the points from the viewing point of the camera 120 (camera position), the point B would be incorrectly labeled with, for example, a color or label from the upper side of the object 152 or generally associated with an upper side or surface of the object 152.

The points P (also comprising A and B) may be present or represented with coordinates in a coordinate system 200 of the lidar sensor 110 with the lidar sensor 110 in the origin 202 of this coordinate system. By way of example, the coordinate system 200 is shown as a Cartesian coordinate system with the axes x and y. An axis z would be perpendicular to the drawing plane and cannot be seen. In this way, each point can be exactly defined. If the coordinate system 200 were one with spherical coordinates, for example, the distances of the points from the origin 202 would correspond to the magnitude of the radial coordinate.

A coordinate system 210 can also be specified for the camera 120, with the camera 120 in the origin 212 of this coordinate system 210. By way of example, the coordinate system 210 is shown as a Cartesian coordinate system with the axes x′ and y′. An axis z′ would be perpendicular to the drawing plane and cannot be seen.

In order to now determine from the quantity of points P (comprising the points A and B) a target quantity of points which are visible from the camera 120, i.e., from a specified viewing point in the surrounding area—the origin of the coordinate system 210—the procedure described below by way of example can be used. This target quantity will then continue to comprise point A, but not point B.

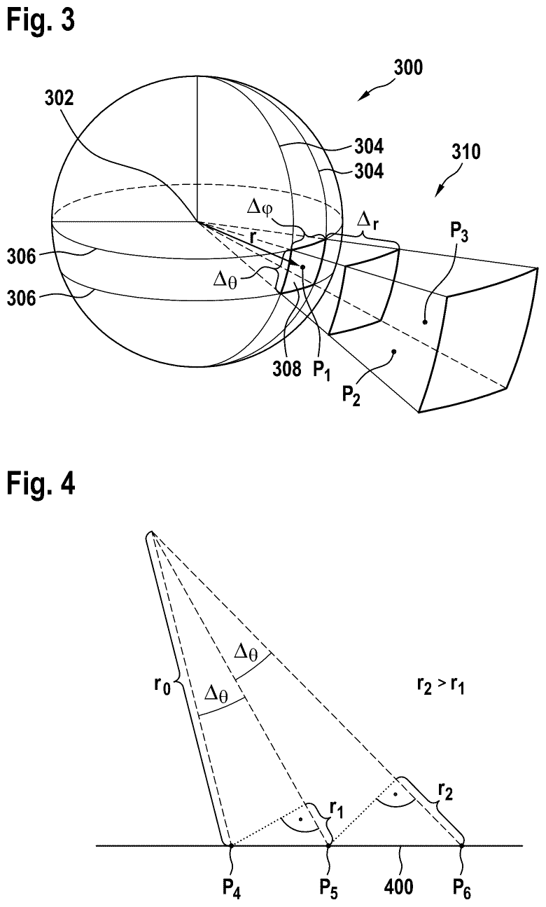

The typical shadowing behavior of a lidar sensor can be considered for the proposed procedure. A 3D lidar sensor scans its surrounding area in a discretized angular pattern, both in horizontal (azimuthal) and vertical (polar) directions. For each discretized point—such as the points P in FIG. 1—the distance to the nearest reflecting surface is always measured. Due to the discretization, no other point is recognized within a certain azimuthal and vertical or polar spacing from a point. Figuratively speaking, this means that the recognized point casts a pyramid-shaped shadow on all other points behind it, as can be seen in FIG. 3 and will be explained later.

This behavior of a lidar sensor is now to be simulated for a different viewing angle or viewing point. To illustrate this, the algorithm is explained using the example of converting lidar data into a camera image, as mentioned above. It should be mentioned again, however, that this can be a transformation from one coordinate system—an origin coordinate system such as the coordinate system 200 in FIG. 2—to any other coordinate system—a target coordinate system such as the coordinate system 210 in FIG. 1—in general and is not limited to the lidar camera application. This is for explanatory purposes only.

For this purpose, a quantity of points or a point cloud _{L}P, which originates from a lidar sensor in the coordinate system (CS)_{L} (e.g., corresponds to the coordinate system 200), can initially be transformed into the camera coordinate system (CS)_{C} (e.g., corresponds to the coordinate system 210), namely by a transformation

_{C}P=T_{CL L}P

wherein

$${T}_{CL} = ( \begin{matrix}{R}_{CL} & {t}_{CL} \\ {0}^{T} & 1\end{matrix} )$$

can be given by an extrinsic calibration. After this transformation, all points P=(x′, y′, z′) in _{c}P can then be converted or transformed into spherical coordinates \hat{P}=(r, θ, φ) using the following equations. For this purpose, it should be mentioned that typical robot coordinate orientations are assumed with x for forward, y for left and z for up.

This transformation from Cartesian to spherical coordinates is effected, for example, according to

$$r = \sqrt{( {x}^{′2} + {y}^{′2} + {z}^{′2}}$$

$$φ = arctan ( \frac{{z}^{′}}{r} )$$

$$θ = arctan ( \frac{{y}^{′}}{{x}^{′}} )$$

If the points in the origin coordinate system are already present in spherical coordinates, only the transformation into the target coordinate system is necessary.

Furthermore, a spherically curved or spherical grid G with cells Gᵢⱼ of a certain dimension (size) Δθ×Δφ in polar direction or azimuth direction is determined in the target coordinate system. Such a grid 310 with cells 308 is shown in FIG. 3 in a coordinate system with origin 302 and in spherical coordinates. Each cell is defined here, for example, by two grid lines 304, which run in the polar direction, and two grid lines 306, which run in the azimuth direction. The following is to apply, for example:

$$0 \leq i ≦ \frac{360 °}{Δφ} , i ∈ {ℕ}_{0}$$

$$0 \leq j ≦ \frac{180 °}{Δθ} , j ∈ {ℕ}_{0} .$$

Subsequently, each point \hat{P} is assigned to one of these cells, for example by determining its coordinates according to:

$${i}_{\hat{P}} = ⌊ \frac{{φ}_{\hat{P}}}{Δφ} ⌋ ,$$

$${j}_{\hat{P}} = ⌊ \frac{{θ}_{\hat{P}}}{Δθ} ⌋ .$$

It should be noted that a cell describes an entire truncated cone in 3D space, as indicated in FIG. 3.

As mentioned, there can then be cells to which no point is assigned, cells to which exactly one point is assigned and cells to which more than one point is assigned. In the example in FIG. 3, for example, three points P₁, P₂ and P₃ are assigned to cell 308. For each cell with a plurality of points, the point with the smallest or minimum spacing to the coordinate origin, here origin 302, can be determined, for example by comparing the respective values for the radial coordinate (r coordinate component). The minimum or smallest r or the minimum spacing for a cell can be designated, for example, as r₀.

Furthermore, all points of the cell with a spacing that exceeds the minimum spacing r₀ by more than a specified first threshold value Δr i.e., for which

$$r > {r}_{0} + Δ r$$

applies, can then be identified and removed from the entire original quantity of points. Thereby,

$$Δ r = {α}_{r} \cdot {r}_{0}$$

can apply. A reason for such a (first) threshold value Δr is, for example, of a practical nature. Due to the different viewing angle between camera and lidar, a cell can also contain a plurality of points that lie next to one another on a nearby area. These are not to be, for example, removed, but only those that are significantly further away are to be removed.

A method for the determination of Δr by multiplication with a factor αᵣ also results, for example, from practical considerations; this is illustrated in FIG. 4. For points that lie in planes such as plane 400, which are orthogonal to the image plane, the difference between the _xD835_xDC5F coordinates of the points, here points P₄, P₅, P₆, with a fixed Δθ-offset increases the further away these points are. These differences relative to the minimum spacing r₀ are labeled r₁ or r₂ respectively. For this reason, Δr is to be determined multiplicatively to avoid incorrectly removing points that lie on the same planes.

Depending on the application, the (first) threshold value Δr could also be determined using other functions, for example as an exponential function or as a constant.

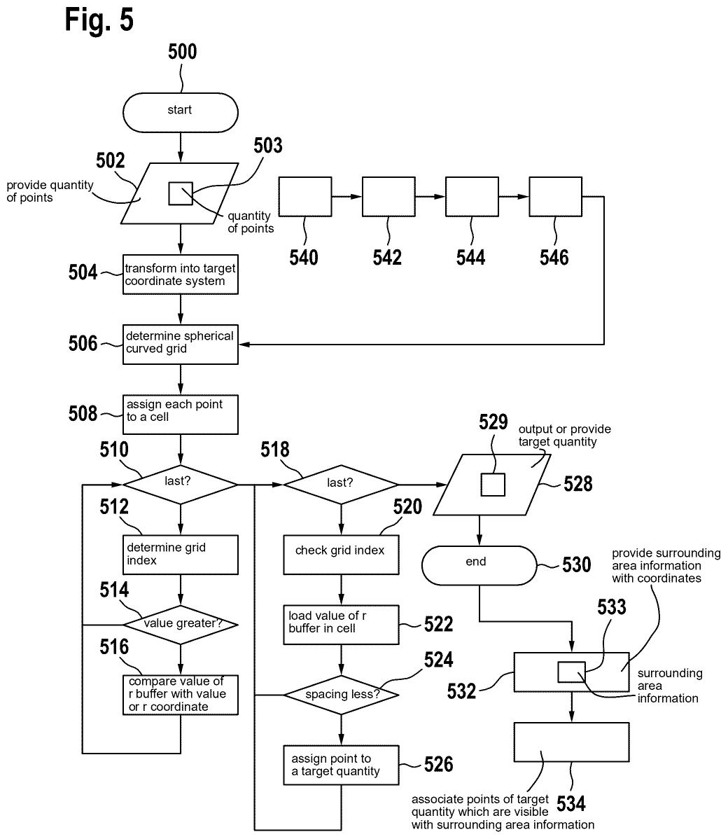

FIG. 5 shows by way of example a method according to the present invention in a preferred embodiment as a flow chart. After a start 500, in step 502, a quantity 503 of points (or generally point groups) is provided. In addition to the quantity of points or a point cloud _{L}P, which was detected or recorded by a lidar (or other) sensor, for example, the input for the algorithm described also comprises an extrinsic transformation T_{CL} into a different coordinate system with a different origin (e.g., that of a camera). The algorithm then aims to modify the point cloud in such a way that, if the point cloud were viewed from a different position or viewing point, points that would lie behind objects in the original scene are removed.

For this purpose, in a step 504, the quantity of points or the point cloud _{L}P is then transformed from the original or lidar sensor coordinate system into the target coordinate system of interest with the aid of the transformation Ta as a result of which the transformed point cloud _{c}P is obtained, specifically in spherical coordinates, i.e., for each point there are coordinates of the form \hat{P}=(r, θ, φ). The transformation typically does not result directly in the spherical coordinates, but the conversion to spherical coordinates may have to be carried out separately. This quantity of points in spherical coordinates can also designated as _{c}\hat{P}.

In a step 506, a spherically curved grid is determined in spherical coordinates, as explained with reference to FIG. 3. In particular, a so-called “r buffer” can be initialized, in which the point with the minimum spacing can (later) be stored for each cell. For each cell, this value of the “r buffer” can initially be initialized to, for example, infinity.

In a step 508, each point is assigned to a cell. The point with the minimum spacing from the origin of the target coordinate system can also be determined for this cell.

This can be effected in a kind of loop, so that, for example, in a step 510 it is always checked whether the point for which an assignment to a cell has just been made is the last of the quantity _{c}\hat{P}. If not, in step 512 a grid index (i, j), as mentioned above, i.e., the cell to which the point is to be assigned is determined. Thus, the corresponding grid index can be calculated for each point on the basis of its spherical coordinates. The grid index corresponding to the point (e.g., marked by a point index) is saved for later use.

In step 514, it is then possible to check whether the value of the “r buffer” of this cell is greater than the value of the r coordinate of the current point. If yes, this means that the current point has a smaller spacing than another point assigned to this cell. Then, in step 516, the value of the “r buffer” of this cell is compared with the value of the r coordinate of the current point.

In this way, all points are assigned to a cell and the point with the minimum spacing or at least the value of this minimum spacing is determined for each cell.

If it is specified during the loop in step 510 that the point for which an assignment to a cell has just been made was the last of the quantify _{c}\hat{P}, certain points are identified for all those cells to which more than one point is assigned, which can be removed from the quantity.

This as well can be effected in a kind of loop, so that, for example, in a step 518 it is always checked whether the point for which a check has just been carried out was the last of the quantity _{c}\hat{P}. If not, the grid index of the current point, for example, is checked in step 520, i.e., the cell to which it is assigned is checked. In a step 522, for example, the value of the “r buffer” of this cell can be loaded (this was determined in the previous loop). This value corresponds to the minimum spacing r₀.

In a step 524, it is then checked whether the spacing, i.e., the value of the r coordinate of the current point, is less than or equal to the minimum spacing plus the mentioned (first) threshold value, i.e., whether the following applies:

$$r ( \hat{P} ) \leq {r}_{0} + Δ r$$

If this is the case, the point is assigned to a target quantity _{c}\tilde{P} in step 526. If this is not the case, nothing is done, so the point in question is not considered further.

If it is specified during the loop in step 518 that the point for which a check has just been effected was the last of the quantity _{c}\hat{P}, the resulting target quantity _{c}\tilde{P} or 529 can be output or provided in a step 528, and the method can end in step 530.

It should be mentioned that instead of checking in step 524 whether the spacing, i.e., the value of the r coordinate of the current point, is less than or equal to the minimum spacing plus the mentioned (first) threshold value, it is also possible to check whether the value of the r coordinate of the current point is greater than the minimum spacing plus the mentioned (first) threshold value, i.e., whether the following applies:

$$r ( \hat{P} ) \leq {r}_{0} + Δ r$$

In this case, if that is true, the point would be removed from the quantity _{c}\hat{P} in an alternative step 526. If this is not true, nothing is done, so the point in question remains in the quantity _{c}\hat{P} The remaining quantity _{c}\hat{P} can then be used in an alternative step 528 as the target quantity _{c}\tilde{P} can be output or provided.

Furthermore, it is preferred if, in a step 532, surrounding area information 533, such as image information or images, is provided with coordinates in the target coordinate system. In a step 534, the points of the target quantity which are visible from a specified viewing point in the surrounding area may then be associated with the surrounding area information.

Furthermore, within the scope of the method according to the present invention in a preferred embodiment, the parameters Δφ and Δθ (spacings) required for the grid can also be automatically derived or determined from the given quantity of points or the point cloud _{L}P. It can be assumed, for example, that the point cloud originates from a typical laser scanner (lidar sensor), which has characteristic rings around the vertical axis.

For this purpose, in a step 540, coordinates of the quantity of points, i.e., points in _{L}P in the origin coordinate system are determined in spherical coordinates, if they are not already present in this way.

In a step 542, a frequency distribution of the points in the polar direction is then determined, i.e., a θ histogram is created. For this purpose, the θ coordinates of all points can initially be binned with a certain accuracy, for example 2¹⁶ bins. The histogram (frequency distribution) then contains peaks of approximately the same height for each laser ring. These peaks can be counted by initially applying a threshold value to the histogram in order to, for example, remove noise, and then finding and counting local maxima.

In a step 544, for example, a dimension (angle) of the cells in the polar direction is then determined based on the number of local maxima of the frequency distribution. The value for the spacing, Δθ, can be determined according to

$$Δθ = \frac{180 °}{N}$$

where N indicates the number of local maxima of the frequency distribution. In a step 546, for example, a dimension (angle) of the cells in the azimuth direction is determined based on a number of point groups per local maximum. The value for the spacing, Δφ, can be determined directly from that of a peak, since this height corresponds to the number of points with a certain value of θ. In practice, not all measurements lead to a point in the point cloud, and therefore Δφ is to preferably be determined based on the maximum number of points in a single laser ring, for example according to

$$Δφ = \frac{360 °}{N}$$

wherein M is the number of points per local maximum of the frequency distribution. In practice, multiplying both parameters by a factor of 2 (or a factor greater than 2) leads to more robust results. As a result, it is substantially ensured that visible and obscured points end up in similar cells, rather than each receiving its own cell and not being filtered. It is understood that other values or factors can also be used for multiplication. These spacings can also be adjusted or specified based on a distance of the specified viewing point from an origin of the origin coordinate system.

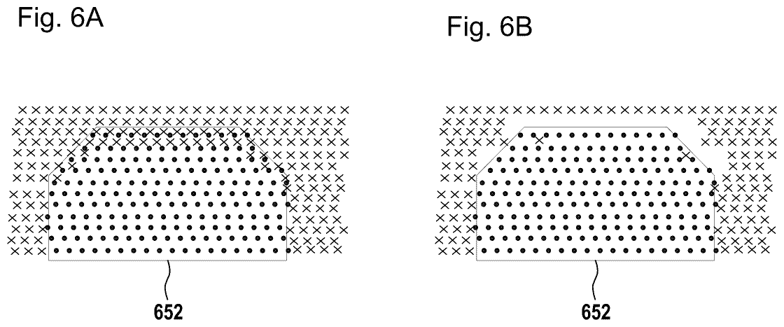

FIGS. 6A and 6B show exemplary representations of before and after the application of a proposed method. For this purpose, an object contour 652 is drawn on the left (FIG. 6A), as seen from the camera of the device, for example along the axis x′ in accordance with FIG. 2. In contrast to FIG. 2, the lidar sensor should be arranged slightly higher than the camera, so that it can see over the object better, so to speak.

Here, spheres (dots) are used to mark points that lie on the object, while crosses are used to mark points that lie behind the object. Both types of points are detected by the lidar sensor; the different representation is to only serve for explanatory purposes. It can be seen here that when the points of the lidar sensor are transformed into the coordinate system of the camera (as in FIG. 6A), points that are actually behind the object are projected onto the object.

On the right (FIG. 6B), the object contour 652 is also shown, but certain points are removed there in accordance with a method according to the present invention in a preferred embodiment. It can be seen that almost all the points behind the object that were previously mapped onto the object are now no longer present. It should be mentioned that the object contour 652 is only shown here for illustrative purposes; it is not known to the algorithm used to remove the points.

1-15. (canceled)

16. A method for determining a target quantity of point groups in a surrounding area for navigation for an at least partially automated moving vehicle, the point groups being visible or not visible from a specified viewing point in the surrounding area, from a quantity of point groups, wherein each point group includes one or more points, the method comprising the following steps:
providing the quantity of point groups in the surrounding area with coordinates in an origin coordinate system;
transforming the coordinates of the quantity of point groups into spherical coordinates in a target coordinate system, wherein the viewing point in the surrounding area lies in an origin of the target coordinate system;
determining a spherically curved grid in spherical coordinates in the target coordinate system, wherein the grid includes grid points and/or cells;
assigning each point group of at least some of the quantity to a cell in the grid or a grid point in the grid;
for each of at least some of the cells of the grid or for each of at least some of the grid points of the grid assigned to more than one point group: determining a minimum and/or maximum spacing based on spacings of the point groups from the origin of the target coordinate system;
performing:
a) determining a target quantity of point groups visible from the specified viewing point in the surrounding area, including those point groups whose spacing from the origin of the target coordinate system per cell or grid point exceeds the minimum spacing by at most a specified first threshold value, and/or whose spacing from the origin of the target coordinate system per cell or grid point is less than the maximum spacing minus a specified second threshold value, and including those point groups which are assigned to cells or grid points to which only one point group is assigned, and/or
b) determining a target quantity of point groups which are not visible from the specified viewing point in the surrounding area, comprising those point groups whose spacing from the origin of the target coordinate system per cell or grid point exceeds the minimum spacing by more than the specified first threshold value, and/or whose spacing from the origin of the target coordinate system per cell or grid point exceeds the maximum spacing minus the specified second threshold value; and
providing, for use for navigation and/or movement of the at least partially automated moving vehicle: (i) the determined target quantity of point groups visible from the specified viewing point in the surrounding area, and/or (ii) the determine target quantity of point groups not visible from the specified viewing point in the surrounding area.

17. The method according to claim 16, wherein the specified first and/or the second threshold value depends on a respective minimum or maximum spacing, corresponding to the respective minimum or maximum spacing multiplied by a respective factor.

18. The method according to claim 16, wherein the determining of the grid in spherical coordinates in the target coordinate system includes:
determining or using the coordinates of the quantity of point groups in the origin coordinate system in spherical coordinates;
determining a frequency distribution of the point groups in a polar direction;
determining a dimension of the cells or of spacings of the grid points in the polar direction based on a number of local maxima of the frequency distribution; and
determining a dimension of the cells or the spacings of the grid points in an azimuth direction based on a number of point groups per local maximum.

19. The method according to claim 16, wherein a dimension of the cells or spacings of the grid points in a polar direction and/or a dimension of the cells or spacings of the grid points in an azimuth direction is determined based on a distance of the specified viewing point from an origin of the origin coordinate system.

20. The method according to claim 16, wherein the quantity of point groups in the surrounding area is determined using distance measurement via a lidar sensor.

21. The method according to claim 20, wherein a position of the lidar sensor lies in an origin of the origin coordinate system.

22. The method according to claim 16, further comprising:
providing surrounding area information with coordinates in the target coordinate system; and
associating at least some of the point groups of the target quantity of point groups which are visible from a specified viewing point in the surrounding area with the surrounding area information.

23. The method according to claim 22, wherein the surrounding area information includes image information and/or semantic information determined using an image sensor.

24. The method according to claim 23, wherein the surrounding area information is represented as seen from the specified viewing point, and wherein a position of the image sensor lies in the origin of the target coordinate system.

25. The method according to claim 22, further comprising:
determining control information for moving a device based on the surrounding area information and the point groups of the target quantity associated with the surrounding area information; and
providing the control information and controlling the device based on the control information.

26. A system for data processing configured to determine a target quantity of point groups in a surrounding area for navigation for an at least partially automated moving vehicle, the point groups being visible or not visible from a specified viewing point in the surrounding area, from a quantity of point groups, wherein each point group includes one or more points, the system configured to:
provide the quantity of point groups in the surrounding area with coordinates in an origin coordinate system;
transform the coordinates of the quantity of point groups into spherical coordinates in a target coordinate system, wherein the viewing point in the surrounding area lies in an origin of the target coordinate system;
determine a spherically curved grid in spherical coordinates in the target coordinate system, wherein the grid includes grid points and/or cells;
assign each point group of at least some of the quantity to a cell in the grid or a grid point in the grid;
for each of at least some of the cells of the grid or for each of at least some of the grid points of the grid assigned to more than one point group: determine a minimum and/or maximum spacing based on spacings of the point groups from the origin of the target coordinate system;
perform:
a) determining a target quantity of point groups visible from the specified viewing point in the surrounding area, including those point groups whose spacing from the origin of the target coordinate system per cell or grid point exceeds the minimum spacing by at most a specified first threshold value, and/or whose spacing from the origin of the target coordinate system per cell or grid point is less than the maximum spacing minus a specified second threshold value, and including those point groups which are assigned to cells or grid points to which only one point group is assigned, and/or
b) determining a target quantity of point groups which are not visible from the specified viewing point in the surrounding area, comprising those point groups whose spacing from the origin of the target coordinate system per cell or grid point exceeds the minimum spacing by more than the specified first threshold value, and/or whose spacing from the origin of the target coordinate system per cell or grid point exceeds the maximum spacing minus the specified second threshold value; and
provide, for use for navigation and/or movement of the at least partially automated moving vehicle: (i) the determined target quantity of point groups visible from the specified viewing point in the surrounding area, and/or (ii) the determine target quantity of point groups not visible from the specified viewing point in the surrounding area.

27. A device configured to:
provide a quantity of point groups in a surrounding area, with coordinates in an origin coordinate system;
obtain a target quantity of point groups which are visible or not visible from a specified viewing point in the surrounding area, which has been determined from the quantity of points by:
transforming the coordinates of the quantity of point groups into spherical coordinates in a target coordinate system, wherein the viewing point in the surrounding area lies in an origin of the target coordinate system;
determining a spherically curved grid in spherical coordinates in the target coordinate system, wherein the grid includes grid points and/or cells;
assigning each point group of at least some of the quantity to a cell in the grid or a grid point in the grid;
for each of at least some of the cells of the grid or for each of at least some of the grid points of the grid assigned to more than one point group:
determining a minimum and/or maximum spacing based on spacings of the point groups from the origin of the target coordinate system;
performing:
a) determining a target quantity of point groups visible from the specified viewing point in the surrounding area, including those point groups whose spacing from the origin of the target coordinate system per cell or grid point exceeds the minimum spacing by at most a specified first threshold value, and/or whose spacing from the origin of the target coordinate system per cell or grid point is less than the maximum spacing minus a specified second threshold value, and
including those point groups which are assigned to cells or grid points to which only one point group is assigned, and/or
b) determining a target quantity of point groups which are not visible from the specified viewing point in the surrounding area,
comprising those point groups whose spacing from the origin of the target coordinate system per cell or grid point exceeds the minimum spacing by more than the specified first threshold value, and/or whose spacing from the origin of the target coordinate system per cell or grid point exceeds the maximum spacing minus the specified second threshold value; and
providing, for use for navigation and/or movement of the at least partially automated moving vehicle: (i) the determined target quantity of point groups visible from the specified viewing point in the surrounding area, and/or (ii) the determine target quantity of point groups not visible from the specified viewing point in the surrounding area.

28. The device according to claim 27, wherein the device is: (i) an at least partially automated moving vehicle including a passenger transportation vehicle or a goods transportation vehicle, and/or (ii) a robot, and/or (iii) a drone.

29. A non-transitory computer-readable storage medium on which is stored a computer program for determining a target quantity of point groups in a surrounding area for navigation for an at least partially automated moving vehicle, the point groups being visible or not visible from a specified viewing point in the surrounding area, from a quantity of point groups, wherein each point group includes one or more points, the computer program, when executed by a computer, causing the computer to perform the following steps:
providing the quantity of point groups in the surrounding area with coordinates in an origin coordinate system;
transforming the coordinates of the quantity of point groups into spherical coordinates in a target coordinate system, wherein the viewing point in the surrounding area lies in an origin of the target coordinate system;
determining a spherically curved grid in spherical coordinates in the target coordinate system, wherein the grid includes grid points and/or cells;
assigning each point group of at least some of the quantity to a cell in the grid or a grid point in the grid;
for each of at least some of the cells of the grid or for each of at least some of the grid points of the grid assigned to more than one point group: determining a minimum and/or maximum spacing based on spacings of the point groups from the origin of the target coordinate system;
performing:
a) determining a target quantity of point groups visible from the specified viewing point in the surrounding area, including those point groups whose spacing from the origin of the target coordinate system per cell or grid point exceeds the minimum spacing by at most a specified first threshold value, and/or whose spacing from the origin of the target coordinate system per cell or grid point is less than the maximum spacing minus a specified second threshold value, and including those point groups which are assigned to cells or grid points to which only one point group is assigned, and/or
b) determining a target quantity of point groups which are not visible from the specified viewing point in the surrounding area, comprising those point groups whose spacing from the origin of the target coordinate system per cell or grid point exceeds the minimum spacing by more than the specified first threshold value, and/or whose spacing from the origin of the target coordinate system per cell or grid point exceeds the maximum spacing minus the specified second threshold value; and
providing, for use for navigation and/or movement of the at least partially automated moving vehicle: (i) the determined target quantity of point groups visible from the specified viewing point in the surrounding area, and/or (ii) the determine target quantity of point groups not visible from the specified viewing point in the surrounding area.
